(19) United States
(12) Patent Application Publication
(10) Pub. No.: US 2022/0295895 A1
(43) Pub. Date: Sep. 22, 2022

(54) Susceptor used in aerosol generating device and the aerosol generating device

(71) Applicant: SHENZHEN FIRST UNION TECHNOLOGY CO.,LTD., Shenzhen (CN)

(72) Inventors: Zuqiang Qi, Shenzhen (CN); Baoling Lei, Shenzhen (CN); Jian Wu, Shenzhen (CN); Jiamao Luo, Shenzhen (CN); Zhongli Xu, Shenzhen (CN); Yonghai Li, Shenzhen (CN)

(21) Appl. No.: 17/836,028

(22) Filed: Jun. 9, 2022

Related U.S. Application Data
(63) Continuation of application No. PCT/CN2020/134981, filed on Dec. 9, 2020.

(30) Foreign Application Priority Data
Dec. 10, 2019 (CN) 201911256219.7

(51) Int. Cl. A24F 40/465; A24F 40/42; H05B 6/10

(52) U.S. Cl. CPC A24F 40/465; A24F 40/42; H05B 6/105

(57) ABSTRACT

The susceptor includes: a metal body, being penetrable by a changing magnetic field to generate heat; a protective layer formed on the metal body, the protective layer having a surface micro-nano structure with a lotus effect so that the adhesion or deposition of organic substances from a smokable material on the surface of the susceptor is reduced. The solid substances such as tobacco slags and dust may hard to break through the micro-nano structure and directly infiltrate into the surface and the smallest diameter of aerosol condensate oil and water vapor or the like is larger than the micro-nano structure, so that spherical bodies which are easy to roll down are formed by the aerosol condensate oil and water vapor under the action of their own surface tension, thereby preventing the adhesion or deposition of organic substances on the surface.

### CROSS-REFERENCES TO RELATED APPLICATIONS

This application is based upon and claims priority to Chinese Patent Application No. 201911256219.7, filed with the Chinese Patent Office on Dec. 10, 2019, titled “SUSCEPTOR FOR AEROSOL GENERATING DEVICE, AEROSOL GENERATING DEVICE”, the entire contents of which are incorporated herein by reference.

### TECHNICAL FIELD

The present application relates to the field of electromagnetic inductive smoking sets which are incombustible when being heated, and in particular, relate to a susceptor for an aerosol generating device and an aerosol generating device.

### BACKGROUND

Tobacco products (e.g., cigarettes, cigars, etc.) burn tobacco to produce tobacco smoke during use. Attempts have been made to replace these tobacco-burning products by manufacturing products that release compounds without burning.

An example of such products is a heating device, which releases compounds by heating a material instead of burning it. For example, the material may be tobacco or other non-tobacco products, and the non-tobacco products may or may not contain nicotine. As an example, an inductive heater with appropriate magnetic permeability is used to generate heat under the induction of alternating magnetic field, thereby heating tobacco products and releasing compounds to form aerosol for smoking. The known inductive heater is usually made of stainless iron, iron-nickel alloy and other materials containing iron and nickel and with suitable magnetic permeability. Thus, the heater has relatively active surface properties, and slags of tobacco products and organic substances generated by aerosol condensation are easily adhered to the surface of the heater during use.

### SUMMARY

In the first aspect, the embodiment of the present application discloses a susceptor for an aerosol generating device. The susceptor includes: a metal body, being penetrable by a changing magnetic field to generate heat; a protective layer provided on the metal body, wherein the protective layer has a surface micro-nano structure with a lotus effect so that the adhesion or deposition of organic substances from the smokable material on the surface of the susceptor is reduced.

Optionally, the thickness of the protective layer ranges from 5 μm to 35 μm.

Optionally, the protective layer comprises a ceramic material and an organic polymer material.

Optionally, the ceramic material comprises at least one of aluminium oxide and titanium dioxide.

Optionally, the organic polymer material comprises polyorganosiloxane.

Optionally, the weight percentage of the polyorganosiloxane in the protective layer is less than 5%.

Optionally, the polyorganosiloxane comprises at least one of methyl silicone oil, dimethyl silicone oil or ethyl silicone oil.

Optionally, the hot state pencil hardness of the protective layer is from 6H to 8H under the GB/T6739-2006 standard.

Optionally, a water contact angle of the surface of the protective layer is greater than 120 degrees.

Optionally, the adhesion level between the protective layer and the metal body reaches Grade 1.

Optionally, the protective layer has a thermal decomposition temperature greater than 320° C.

In the second aspect, the embodiment of the present application discloses an aerosol generating device for heating a smokable material to generate aerosol. The aerosol generating device includes: a cavity, being configured to receive at least a part of the smokable material; a magnetic field generator, being configured to generate an alternating magnetic field; a heater, being configured to be penetrated by the alternating magnetic field to heat the smokable material received in the cavity; and the heater includes the susceptor for the aerosol generating device described above.

### BRIEF DESCRIPTION OF THE DRAWINGS

One or more embodiments are illustrated by pictures in the corresponding attached drawings, and this does not constitute the limitation of the embodiments. Elements with the same reference numerals in the attached drawings represent similar elements, and unless otherwise stated, the figures in the attached drawings do not constitute the scale limitation.

FIG. 1 is a schematic view of an aerosol generating device according to an embodiment.

FIG. 2 is a schematic view of a tubular susceptor according to an embodiment.

FIG. 3 is a cross-sectional schematic view of a susceptor according to an embodiment.

FIG. 4 is a micro-topography diagram of silicon dioxide, titanium dioxide and alumina powders according to an embodiment.

FIG. 5 is a surface micro-topography diagram of a protective layer prepared from nano-ceramic and polysiloxane.

FIG. 6 is a surface micro-topography diagram of a protective layer prepared from nano-ceramic and polysiloxane.

FIG. 7 is an energy spectrum analysis diagram of a selected point of the protective layer prepared in FIG. 6.

FIG. 8 is a test chart of the water contact angle of the surface of the protective layer in FIG. 6 for the susceptor.

FIG. 9 is a micro-topography diagram of titanium dioxide and alumina powder raw materials in an embodiment.

FIG. 10 is a micro-topography diagram of titanium dioxide and alumina coating in an embodiment.

FIG. 11 is a micro-topography diagram of a PTFE coating further provided on the surface of the coating of FIG. 10.

FIG. 12 is a cross-sectional micro-topography diagram of a protective layer prepared from polytetrafluoroethylene/Al₃O₂—TiO₂.

FIG. 13 is a test chart of the water contact angle of the protective layer of FIG. 12.

FIG. 14 is a micro-topography diagram of a protective layer prepared from water-based nano-TiO₂/PTFE fluorocarbon.

FIG. 15 is a surface micro-topography diagram of a protective layer prepared from SiO₂—Al₃O₂/PTFE.

FIG. 16 is a cross-sectional micro-topography diagram of a protective layer prepared from SiO₂—Al₃O₂/PTFE.

FIG. 17 is a test chart of the water contact angle of the protective layer of FIG. 16.

### DETAILED DESCRIPTION

In order to facilitate the understanding of the present application, the present application will be explained in more detail below with reference to the attached drawings and specific embodiments.

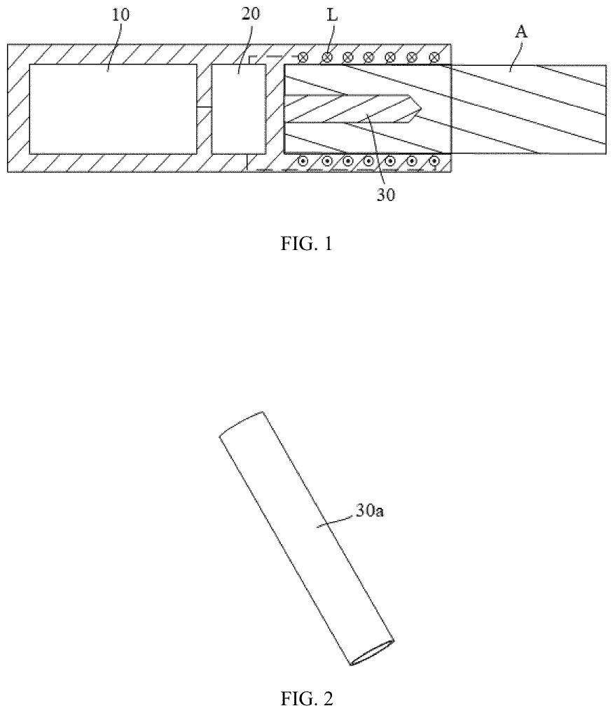

The present application discloses an aerosol generating device for inductive heating, and referring to FIG. 1, the structure thereof in one embodiment includes: a cavity in which a smokable material A, such as a cigarette, is removably received; an inductance coil L as a magnetic field generator, being configured to generate an alternating magnetic field under an alternating current; a susceptor 30 with at least a part thereof extending in the cavity, and being configured to be inductively coupled with the inductance coil L and generate heat when penetrated by the alternating magnetic field so as to heat the smokable material A to volatilize at least one component of the smokable material A to form aerosol for smoking; an electric core 10, being a rechargeable DC electric core capable of providing DC voltage and DC current; a circuit 20, being electrically connected to the rechargeable electric core 10, and being configured to convert the DC output from the electric core 10 into AC with a suitable frequency and supply the AC to the inductance coil L.

According to the setting of the product in use, the susceptor 30 is in the shape of a sheet or pin inserted into the smokable material A for heating. Alternatively, the susceptor has a length of about 15 mm, a width of about 6 mm and a thickness of about 1 mm.

In another embodiment, as shown in FIG. 2, the susceptor 30a may also be constructed in a cylindrical shape. During use, the inner space of the susceptor 30a is used to receive the smokable material A, and the outer periphery of the smokable material A is heated to generate aerosol for smoking.

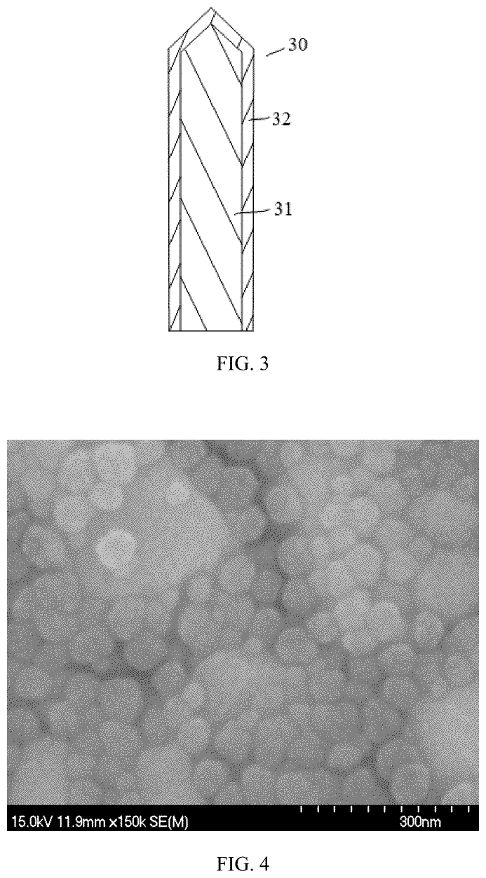

In an embodiment of the present application, referring to FIG. 3, the structure of the susceptor 30 may include: a metal body 31, which is configured to generate heat when penetrated by the changing magnetic field so as to heat the smokable material; in a preferred embodiment, the metal body 31 is made of stainless iron, nickel steel, permalloy and other alloy materials containing iron or nickel and with excellent magnetic permeability; a protective layer 32, being provided on the surface of the metal body 31 and being smoother than the metal body 31.

In an embodiment, the protective layer 32 is a protective layer 32 with a surface micro-nano structure. Materials with micro-nano structure on the surface have a large number of mastoids with slightly concave tops on the surface under the microscope, and the concave parts are filled with air, thereby forming an air layer with thickness on nanoscale on the surface of the protective layer. In this way, on the one hand, it is relatively hard for solid substances such as tobacco slags and dust to break through the air layer and directly infiltrate into the surface of the protective layer 32; and on the other hand, when liquid such as aerosol condensate oil and water vapor adheres to the surface of the protective layer 32, the smallest diameter (about 1 mm) thereof is larger than that of the micro-nano structure, and thus spherical bodies are formed by the liquid under the action of its own surface tension and then roll off the susceptor 30, and this is called the “lotus effect” in the present application.

On the surface of the protective layer 32, organic pollutants such as tobacco slags, aerosol condensate oil and water vapor will be automatically gathered together, instead of being adhered to the surface of the coating. In the process of pulling out the smokable material A, such as a cigarette, after the smoking, the tobacco slags, aerosol condensate oil, water vapor or the like will be pulled out together with the cigarette, without forming stubborn adhesion or deposition on components of the susceptor 30.

In another embodiment, the water static contact angle of the protective layer 32 with the surface micro-nano structure is set to be greater than 120 degrees, so that liquids such as aerosol condensate oil and water vapor can roll on the surface very easily, thereby improving the anti-adhesion effect.

In an embodiment, the protective layer 32 is made of materials with the above micro-nano structure, such as composite materials containing fluoropolymers, e.g., WPU/PTFE alloy resin prepared by adding polytetrafluoroethylene (PTFE) emulsion with strong hydrophobicity into water-based polyurethane (WPU) and then performing spraying and curing operations. The protective layer 32 may also for example be formed of inorganic micro-nano structured materials synthesized by nano-metal oxides, nitrides or the like in liquid phase through the coordination chemistry principle of 1,6-hexamethylenediamine assisted liquid phase method.

In order to provide the protective layer with higher hardness and self-thermal stability, in an embodiment, the protective layer 32 is made of a nano-ceramic composite material prepared from nano-ceramic components and organic polymers.

In one embodiment, for example, materials of surface micro-nano structure with high hardness are used, such as a water-based nano-TiO₂/PTFE fluorocarbon composite material prepared from nano-TiO₂ and polytetrafluoroethylene (PTFE) micropowders and water-based fluorocarbon resin, or a polytetrafluoroethylene/Al₃O₂ composite material, or a polytetrafluoroethylene/Al₃O₂—TiO₂ composite material.

In an embodiment, a composite nano-ceramic composite material prepared by mixing powder of inorganic nano-ceramic such as alumina, silica, titania, zirconia, aluminum nitride, zirconium nitride or the like with organopolysiloxane such as methyl silicone oil, dimethyl silicone oil, ethyl silicone oil or the like is used. By using organopolysiloxane as an assistant, in the chemical change of curing of inorganic nano-ceramic, a part of carbon chains are embedded inside and the other end of silicon-containing elements is exposed on the surface to form a hydrophobic surface through the combination of Si—C bonds and linkage of C—C bonds. Therefore, the hydrophobicity of the surface can be changed while forming the surface micro-nano structure.

In another embodiment, in order to ensure the stability of the nano-ceramic composite material, the weight ratio of organopolysiloxane in the protective layer 32 is controlled to be less than 5%.

The thickness of the protective layer 32 of the above nano-ceramic composite material ranges from 25 μm to 35 μm. Furthermore, the hot state pencil hardness of the protective layer 32 is 6-8H under GB/T6739-2006 (National Standards of the People's Republic of China, GB), wherein the hot state temperature in the hot state pencil hardness test is 300 degrees according to GB standard.

Further, in order to facilitate the verification of improvements in strength, anti-adhesion, and tolerance of the susceptor 30 adopting the above surface micro-nano structure, the prepared susceptors 30 and results thereof will be illustrated through specific embodiments.

### First Embodiment

In the first embodiment of the present application, a sheet susceptor 30 made of a nano-ceramic composite material which has the surface micro-nano structure and is prepared from nano-SiO₂—Al₃O₂—TiO₂ composite powders (at a weight ratio of 2:1:1) and dimethyl silicone oil is taken as an example for description.

S10: material pretreatment was performed, specifically as follows:

S11: a metal body 31 made of permalloy of J85 standard was acquired, and the surface thereof was cleaned and dried;

S12: the metal body 31 was sanded with 80-mesh brown corundum, and the sanding may be performed according to the final surface roughness of the metal body 31 of 3 to 5 microns based on special requirements of improving the bonding strength between the PTFE/Al₃O₂—TiO₂ composite material and the metal body 31.

S20: the protective layer 20 was prepared as follows:

S21: the SiO₂—Al₃O₂—TiO₂ composite powder raw material was ball milled by a high-energy ball mill until the average particle size of the particles is 4080 nm; the micro-topography diagram of the ceramic powder obtained by the high-energy ball milling in one embodiment is as shown in FIG. 4, and the average particle size of the powder particles is about 50˜60 nm;

S22: 1.5 g of sodium polyacrylate as a dispersant, 1.2 g of polyvinyl alcohol as a binder, 0.3 g of T-128 as a bactericide and 0.3 g of curing agent (adipic dihydrazide) were added into 50 ml of a mixed solvent of deionized water and ethanol (1:1) under rapid stirring, and mixed uniformly, and then 15 g of nano-SiO₂—Al₃O₂—TiO₂ powder raw material obtained in step S21 and 0.7 g of dimethyl silicone oil were added and uniformly dispersed to prepare a slurry.

S23: the slurry prepared in step S22 was sprayed on the surface of the metal body 31 that is surface-treated in step S12, wherein the spraying process is performed by a plasma spraying (APS) equipment, and in order to ensure the performance and effect in the spraying process, the nozzle temperature of the spray gun must be preheated before spraying, and otherwise, sagging or shrinkage may occur. Alternatively, it can be sprayed up to 30 microns at one time in practice. After the spraying was completed, the metal body 31 was left to dry naturally for about 30 minutes or so, and then it was put in an oven at 250 degrees for 30 minutes and then taken out to complete the preparation.

S30: in order to verify the self-cleaning ability of the surface of the protective layer 32 prepared from a composite material of nano-SiO₂—Al₃O₂—TiO₂ and dimethyl silicone oil, properties of the susceptor 30 with the protective layer 32 were verified as follows:

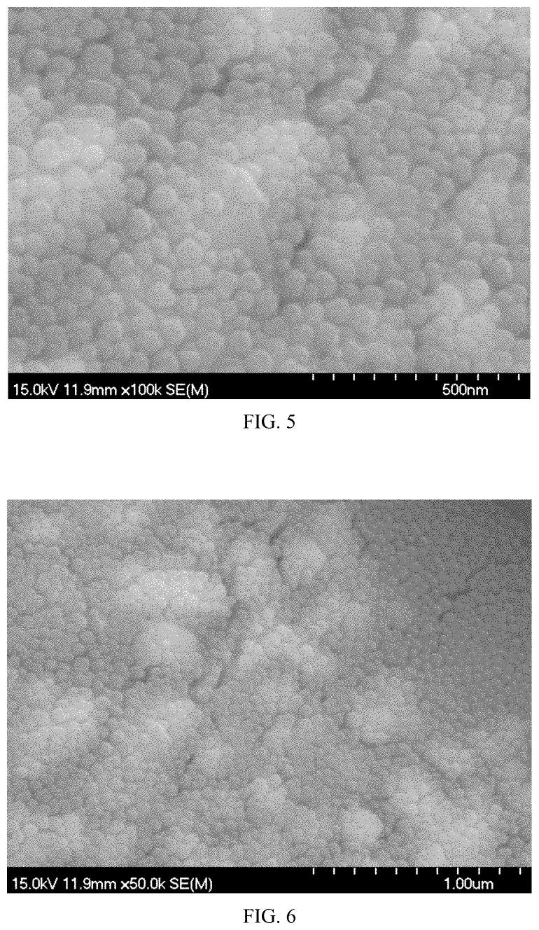

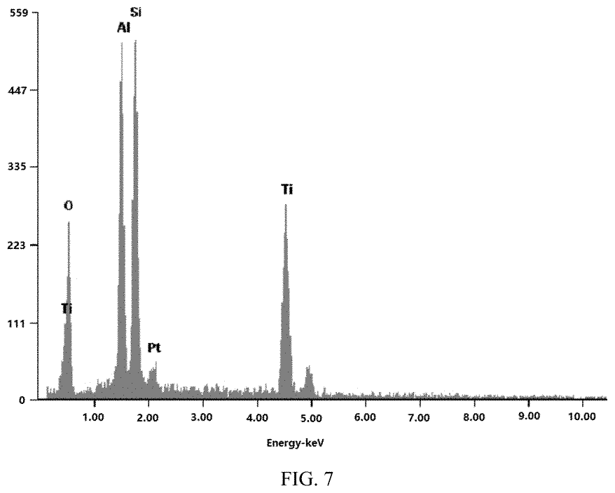

S31: micro-nano structure detection of surface micro-topography: the micro-topography under different magnifications of the scanning electron microscope was as shown in FIG. 5 and FIG. 6; and energy spectrum analysis was carried out on one selected point of the protective layer 32, and as shown in FIG. 7, the selected point exhibited the element proportion finally formed by the above inorganic and organic components.

S32: hot state pencil hardness (300° C.) test under GB/T6739-2006 standard: a Mitsubishi pencil hardness tester was used to scribe a line at a contact angle of 45 degrees with the coating to be tested with a force of 1 KG and a scribing speed of 1 cm/s, and the test result showed that the hardness of the protective layer 32 reaches 6˜8H.

Cold state pencil hardness under GB/T6739-2006 standard: a Mitsubishi pencil hardness tester was used to scribe a line at a contact angle of 45 degrees with the coating to be tested at a force of 1 KG and a scribing speed of 1 cm/s, and the test result showed that the hardness of the protective layer 32 reaches 6˜9H.

S33: adhesion test under GB/T9286-1998: 100 grids of 1 mm*1 mm were cut by a cutting knife on a sample coating with 1 mm at the middle, then the grids were stuck with a 3M adhesive tape, the adhesive tape was pressed hard and then pulled off instantly, and this was performed for five times horizontally and vertically at the same position. A new adhesive tape is used at each time, and in the cutting of the grids, it is necessary to cut the coating through to expose the underlying material, and it is required to cut the main grids uniformly. The adhesion level between the protective layer 32 and the metal body 31 was measured to be 0˜1 grade; and the bonding strength is greater than 4 MPa.

S34: wear resistance test: a 3M friction cloth was soaked in 0.5% detergent and then tied on the cantilever of a frictional machine so that the gravity acting on the surface of susceptor 30 is 3 kg, and the swing reciprocating for one time is counted as one cycle. The 3M friction cloth should be replaced every 250 cycles to test the metal body 31 for which no permalloy is exposed after 3,000 rubs.

S35: 48H salt spray test under GB2423.17 standard: 5% saline water was formulated and placed in a salt spray machine, then the temperature in the salt spray machine is set to be 35° C. to start spraying for 48 hours. There is no corrosion and rust spot on the surface of the susceptor 30 sample, and the sample can meet the tolerance standard for the salt spray test.

S36: performance test of thermal decomposition resistance: in the normal smoking temperature of 320° C. for the aerosol generating device, the color of the protective layer 32 of the susceptor 30 was not change, which indicates that the thermal decomposition temperature of the protective layer 32 can withstand a temperature higher than the smoking and heating temperature of 320° C. for the aerosol generating device in use.

S37: standard anti-fouling performance test: the sample was painted with an oily singular pen and left for 24 hours, and then wiped with an alcohol cotton ball. It turned out that the fouling can be completely wiped up and the surface is clean.

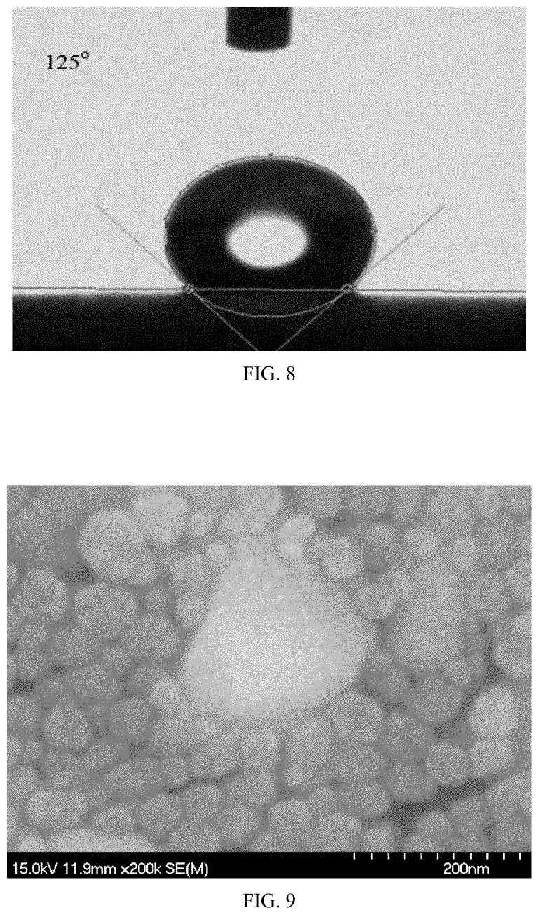

S38: anti-adhesion test for water vapor: the contact angle of the surface thereof was measured by the contact angle measuring instrument JC-2000C1 (produced by Shanghai Zhongchen Digital Technology Equipment Co., Ltd.), and the test result was as shown in FIG. 8, and the maximum contact angle may reach 125°.

S39: anti-adhesion test for tobacco slags: a cigarette (Philip Morris-IQOS), which is incombustible when being heated, was heated by the aerosol generating device with the susceptor 30 for smoking, and the adhesion of tobacco slags and aerosol condensate oil on the surface of the susceptor 30 after the use was checked each time a cigarette is smoked.

The results showed that there were scattered small particles of dust (of which the area is less than 1 mm²) on the surface of the susceptor 30 after the first to thirteenth cigarettes were smoked, and the small particles gradually increased with the number of cigarettes smoked increased, but the particle size was smaller. Meanwhile, the tobacco scraps and condensate oil stains scattered from the cigarettes onto the surface of the susceptor 30 were only slightly stuck to the surface of the susceptor 30, and they can be blown off and shaken off, without forming stubborn deposits and lumps. After the fourteenth cigarette, agglomeration (the area thereof is greater than 4 mm²) of tobacco slags and condensate oil remarkably visible to the naked eyes appeared on the surface of the susceptor 30.

### Second Embodiment

In the second embodiment of the present application, a sheet susceptor 30, having the above-mentioned size and the surface micro-nano structure, made of polytetrafluoroethylene/Al₃O₂—TiO₂ composite material is taken as an example for description.

S10: material pretreatment was performed, specifically as follows:

S11: a metal body 31 made of permalloy of J85 standard was acquired, and the surface thereof was cleaned and dried;

S12: the metal body 31 was sanded with 80-mesh brown corundum, and the sanding may be performed according to the final surface roughness of the metal body 31 of 3 to 5 microns based on special requirements of improving the bonding strength between the PTFE/Al₃O₂—TiO₂ composite material and the metal body 31.

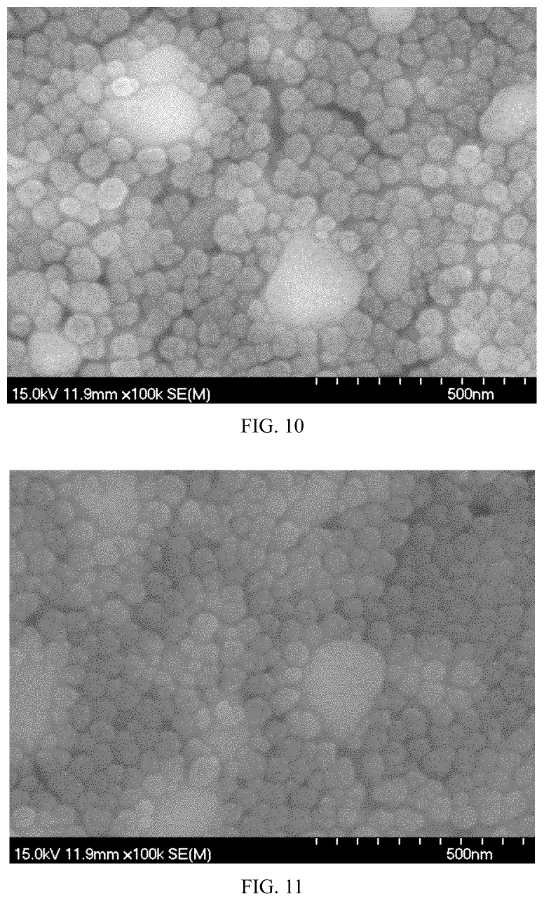

S21: sintered and crushed nano-Al₃O₂—TiO₂ powders were used as a thermal spraying material to form a coating of Al₃O₂—TiO₂ powder with a thickness of about 25 microns on the surface of the metal body 31 by an atmospheric plasma spraying (APS) process. The topography diagram of nano-Al₃O₂—TiO₂ powder is as shown in FIG. 9. In the APS spraying process, the setting conditions of the spraying gun are as follows: the spraying distance is 120 mm, the current is 680 A, and the powder feeding amount is 18 g/min. From the schematic view of the surface micro-topography after spraying shown in FIG. 10, the powders impinged between particles on the surface of the base to form gaps or cracks of different sizes after they were melted by the high-temperature plasma flame, thereby forming many uneven micro-nano structures. This is due to the release of residual stress within the coating at the overlapping peaks during the spraying cooling process, as well as different volume changes during mutual stacking and cooling crystallization caused by different particle temperatures and plastic deformation degrees.

S22: 10 mL of epoxy acrylate, 5 mL of anhydrous ethanol, 5 mL of acetone and 10 mL of deionized water were mixed to prepare a solution with a certain concentration, then 60 mL of PTFE emulsion was slowly dropped into the solution, and stirred by ultrasonic oscillation for 10 min, then 15 mL of acidic SiO₂ sol and a certain amount of coupling agent (KH-550) and curing agent were added and stirred by ultrasonic oscillation for 15 min, and then the mixture is left to stand at room temperature for 1 h to obtain a PTFE composite solution.

S23: the metal body 31 containing the Al₃O₂—TiO₂ coating prepared in step S21 was soaked into the PTFE composite solution in step S22, then the sample was slowly lifted and placed in a mechanical vacuum pump, and a pressure was applied to the surface of the sample by the air pressure in the pump. Finally, a composite coating with a PTFE film was formed on the rough surface of Al₃O₂—TiO₂ coating through the capillary adsorption force of holes and cracks on the surface of the coating to the PTFE solution and the chemical bonding force on the surface of the coating. Subsequently, the composite coating was dried at the room temperature for 6 hours, and then heated in an oven at a constant temperature of 80° C. for 16 hours to finally obtain a protective layer 32 of PTFE/Al₃O₂—TiO₂.

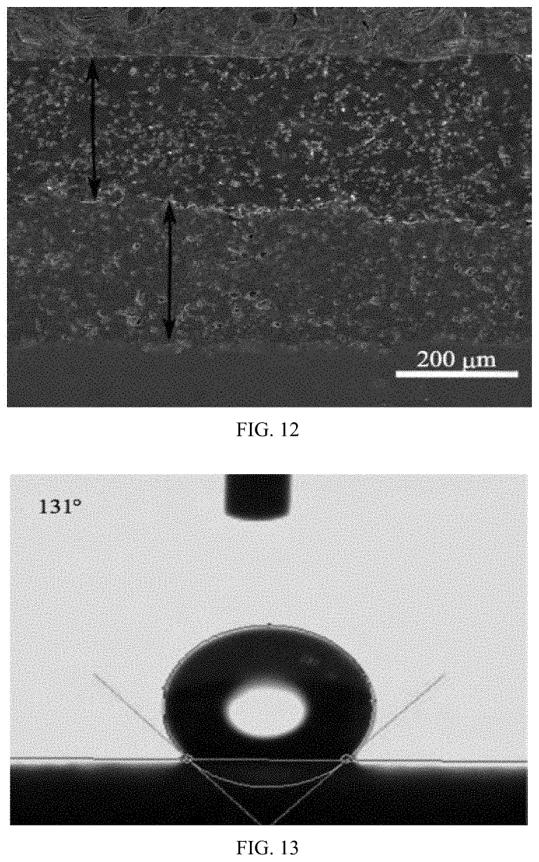

The enlarged micro-topography diagram of the surface of the protective layer 32 prepared in this step is as shown in FIG. 11. The surface of the protective layer 32 has a micro-nano binary rough structure similar to that of the surface of a lotus leaf, and has bright white bumps and pits, and the small mastoid of the columnar structure is the agglomerate of PTFE cured. Meanwhile, in the electron microscope scanning diagram showing the cross-sectional micro-topography of the protective layer 32 of FIG. 12, the inorganic material and the organic material are closely and firmly embedded around the convex particles and holes at the bonding interface.

S30: in order to verify the self-cleaning ability of the surface of the protective layer 32 prepared from materials PTFE/Al₃O₂—TiO₂, properties of the susceptor 30 with the protective layer 32 prepared from PTFE/Al₃O₂—TiO₂ were verified as follows.

S31: hot state pencil hardness (300° C.) test under GB/T6739-2006 standard: a Mitsubishi pencil hardness tester was used to scribe a line at a contact angle of 45 degrees with the coating to be tested with a force of 1 KG and a scribing speed of 1 cm/s, and the test result showed that the hardness of the protective layer 32 reaches 6-8H.

Cold state pencil hardness under GB/T6739-2006 standard: a Mitsubishi pencil hardness tester was used to scribe a line at a contact angle of 45 degrees with the coating to be tested at a force of 1 KG and a scribing speed of 1 cm/s, and the test result showed that the hardness of the protective layer 32 reaches 6˜9H.

S32: adhesion test under GB/T9286-1998: 100 grids of 1 mm*1 mm were cut by a cutting knife on a sample coating with 1 mm at the middle, then the grids were stuck with a 3M adhesive tape, the adhesive tape was pressed hard and then pulled off instantly, and this was performed for five times horizontally and vertically at the same position. A new adhesive tape is used at each time, and in the cutting of the grids, it is necessary to cut the coating through to expose the underlying material, and it is required to cut the main grids uniformly. The adhesion level between the protective layer 32 and the metal body 31 was measured to be 0˜1 grade.

S33: wear resistance test: a 3M friction cloth was soaked in 0.5% detergent and then tied on the cantilever of a frictional machine so that the gravity acting on the surface of susceptor 30 is 3 kg, and the swing reciprocating for one time is counted as one cycle. The 3M friction cloth should be replaced every 250 cycles to test the metal body 31 for which no permalloy is exposed after 3,000 rubs.

S34: standard 48H salt spray test: 5% saline water was formulated and placed in a salt spray machine, then the temperature in the salt spray machine is set to be 35° C. to start spraying for 48 hours. There is no corrosion and rust spot on the surface of the susceptor 30 sample, and the sample can meet the tolerance standard for the salt spray test.

S35: performance test of thermal decomposition resistance: the color of the protective layer 32 was not changed at the normal heating temperature of the smokable material of 250° C. to 320° C. for the aerosol generating device; the protective layer 32 slightly became yellow from white due to the higher temperature thereof when the temperature is further raised to above 450° C., which indicates that the thermal decomposition temperature of the protective layer 32 can withstand a temperature higher than the smoking and heating temperature of the aerosol generating device of 320° C. in use.

S36: standard anti-fouling performance test: the sample was painted with an oily singular pen and left for 24 hours, and then wiped with an alcohol cotton ball. It turned out that the fouling can be completely wiped up and the surface is clean.

S37: anti-adhesion test for water vapor: the contact angle of the surface thereof was measured by the contact angle measuring instrument JC-2000C1 (produced by Shanghai Zhongchen Digital Technology Equipment Co., Ltd.), and the test result was as shown in FIG. 13, and the maximum contact angle may reach 131°.

S38: anti-adhesion test for tobacco slags: a cigarette (Philip Morris-IQOS), which is incombustible when being heated, was heated by the aerosol generating device with the susceptor 30 for smoking, and the adhesion of tobacco slags and aerosol condensate oil on the surface of the susceptor 30 after the use was checked each time a cigarette is smoked.

The results showed that there were scattered small particles of dust (of which the area is less than 1 mm²) on the surface of the susceptor 30 after the first to eleventh cigarettes were smoked, and the small particles gradually increased with the number of cigarettes smoked increased. After the twelfth cigarette, agglomeration (the area thereof is greater than 4 mm²) of tobacco slags and condensate oil remarkably visible to the naked eyes appeared on the surface of the susceptor 30.

### Third Embodiment

In the third embodiment of the present application, a susceptor 30 having the surface micro-nano structure and made of water-based nano-TiO₂/PTFE fluorocarbon composite material is taken as an example for description.

S10: material pretreatment was performed, specifically as follows:

S11: a metal body 31 made of permalloy of J85 standard was acquired, and the surface thereof was cleaned and dried preliminarily;

S12: the metal body 31 was sanded with 80-mesh brown corundum until the surface roughness thereof is 3 to 5 microns.

S21: 40 ml of deionized water was used as solvent, and 3 g of film-forming assistant TEXANOL, 1 g of dispersant SN-5040, 0.8 g of thickener ZT-60, 0.3 g of leveling agent RM-2020, 0.3 g of defoamer NXZ, 0.3 g of bactericide T-128 and 0.3 g of curing agent (adipic dihydrazide) were added thereto under rapid stirring, and mixed uniformly, and then 6 g of nano-TiO₂ and 15 g of PTFE micropowder were added and dispersed uniformly, and then fluorocarbon resin DF-01 powders were added to form a slurry.

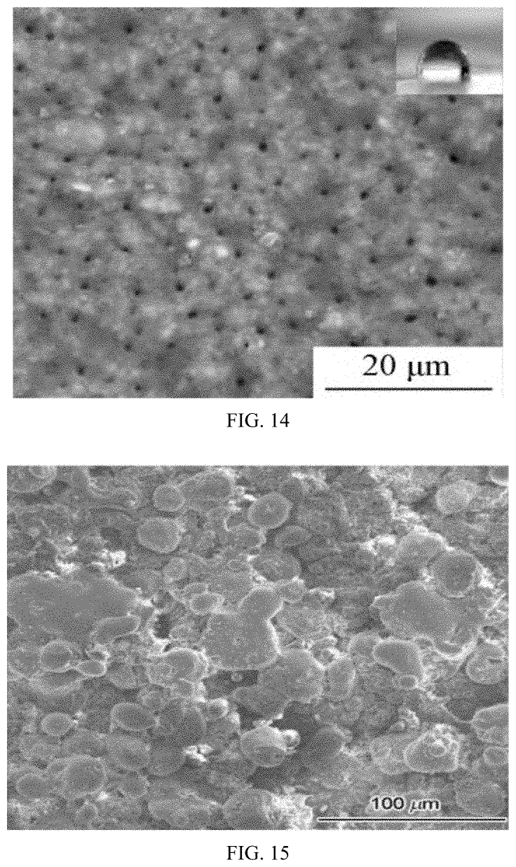

S22: the slurry of step S21 was coated on the surface of the metal body 31 by a roller coater with the thickness controlled to be 35 microns, and then dried and cured at 80 degrees to form the protective layer 32; the surface topography and structure of the protective layer 32 were tested by an electron microscope as shown in FIG. 14, the micro-scale protrusions on the surface of the protective layer 32 made of water-based nano-TiO₂/PTFE fluorocarbon composite material are distributed uniformly and have nanoparticles, thereby forming a rough micro-nano structure.

S30: in order to verify the properties of the protective layer 32 prepared from water-based nano-TiO₂/PTFE fluorocarbon composite material, the properties of the susceptor 30 sample were tested in the same way as in the first embodiment.

S31: standard adhesion test: under GB/T9286-1998, the adhesion level between the protective layer 32 and the metal body 31 was tested to be Grade 1.

S32: hot state pencil hardness (300° C.) test under GB/T6739-2006 standard: the hardness of the protective layer 32 was tested to be 7H.

S33: water resistance: the contact angle of the surface thereof was measured by a contact angle measuring instrument JC-2000C1 (produced by Shanghai Zhongchen Digital Technology Equipment Co., Ltd.), and the test result may be up to 124°; furthermore, the tested result shows that the water resistance can reach grade requirements of >168 h, under GB/T1733-1993.

S34: 8-week accelerated aging test was performed under GB/T14522 to test the ultraviolet aging resistance: the measured result is Grade 2 of (slight) loss of gloss.

S35: 48H salt spray test: 5% saline water was formulated and placed in a salt spray machine, then the temperature in the salt spray machine is set to be 35° C. to start spraying for 48 hours. There is no corrosion and rust spot on the surface of the susceptor 30 sample, and the sample can meet the tolerance standard for the salt spray test.

S36: anti-fouling performance test: the sample was painted with an oily singular pen and left for 24 hours, and then wiped with an alcohol cotton ball. It turned out that the fouling can be completely wiped up and the surface is clean.

S37: anti-adhesion test for tobacco slags: the results showed that after the twelfth cigarette was smoked, agglomeration (the area thereof is greater than 4 mm²) of tobacco slags and condensate oil remarkably visible to the naked eyes appeared on the surface of the susceptor 30.

### Fourth Embodiment

S10: in the fourth embodiment, the composite material powders of composite ceramic and PTFE (at a weight ratio of 2:1) were coated with a thickness of about 30 microns on the surface of SS430 stainless iron metal body 31 after corundum sanding by the atmospheric plasma spraying (APS) process as in the first embodiment, wherein SiO₂: Al₂O₃=2:1 in the composite ceramic powders.

In order to ensure the performance and effect in the spraying process, the nozzle temperature of the spray gun must be preheated before spraying, and otherwise, sagging or shrinkage may occur. Alternatively, it can be sprayed up to 30 microns at one time in practice, and after the spraying is completed, drying and curing were performed to form the protective layer 32.

S20: the surface topography of the protective layer 32 was scanned by electron microscope as shown in FIG. 15, the surface of the protective layer 32 made of SiO₂—Al₂O₃/PTFE composite material had a micro-nano structure with uneven “ellipsoidal” bumps, and some of the bumps are flat “lumps”, and secondary small round particles with smaller sizes grow at the edges and gaps of the bumps.

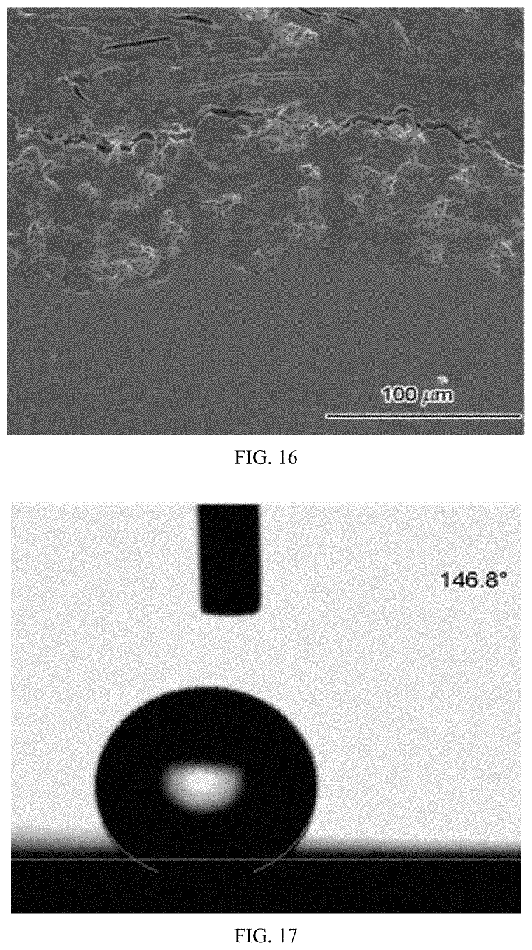

Furthermore, the cross-sectional topography of the protective layer 32 made of the SiO₂—Al₂O₃/PTFE composite material shown in FIG. 16 is not uniformly distributed as a whole. Specifically, due to characteristics of light weight, small specific gravity, high viscosity and short residence time at the outer edge of plasma flame, the PTFE powders were deposited on the partial surface layer during spraying, and finally formed the topography structure including completely melted and partially melted SiO₂-Al₂O₃ particles and PTFE as shown in FIG. 16.

S30: in order to verify the properties of the protective layer 32 prepared from SiO₂—Al₂O₃/PTFE composite material, the properties of the susceptor 30 sample were tested in the same way as that described above.

S31: hot state pencil hardness (300° C.) test under GB/T6739-2006 standard: the hardness of the protective layer 32 was tested to be 6H.

S32: bonding strength test result: Grade 1.

S33: water resistance: the contact angle of the surface thereof was measured by a contact angle measuring instrument JC-2000C1 (produced by Shanghai Zhongchen Digital Technology Equipment Co., Ltd.), and the test result may be up to 146° as shown in FIG. 17.

S34: 48H salt spray test: 5% saline water was formulated and placed in a salt spray machine, then the temperature in the salt spray machine is set to be 35° C. to start spraying for 48 hours. There is no corrosion and rust spot on the surface of the susceptor 30 sample, and the sample can meet the tolerance standard for the salt spray test.

S35: anti-fouling performance test: the sample was painted with an oily singular pen and left for 24 hours, and then wiped with an alcohol cotton ball. It turned out that the fouling can be completely wiped up and the surface is clean.

S36: anti-adhesion test for tobacco slags: the results showed that after the twelfth cigarette was smoked, agglomeration (the area thereof is greater than 4 mm²) of tobacco slags and condensate oil remarkably visible to the naked eyes appeared on the surface of the susceptor 30.

### First Comparative Example

In the first comparative example, the commonly used susceptors 30 made of standard SS430 stainless iron and J85 permalloy were respectively subjected to the following three comparative performance tests:

S10: 48H salt spray test: 5% saline water was formulated and placed in a salt spray machine, then the temperature in the salt spray machine is set to be 35° C. to start spraying for 48 hours.

The result showed that, light but visible rust spots were formed on the surface of standard SS430 stainless iron in the 48H salt spray test, while J85 permalloy could pass the 48H salt spray test.

S20: surface waterproof and anti-aerosol condensate oil test: a small amount of condensate oil was dropped on the surface of susceptors 30 made of standard SS430 stainless iron and J85 permalloy to check the state of oil droplets and the contact angle of the surface thereof was measured by contact angle measuring instrument JC-2000C1 (produced by Shanghai Zhongchen Digital Technology Equipment Co., Ltd.). The result showed that, first the small oil droplets were basically flat after diffusion, which indicates that the surface topography of SS430 stainless iron and J85 permalloy is not enough to maintain the surface tension so as to maintain the spherical shape of the droplets. Then, the contact angle of the susceptor 30 made of SS430 stainless iron was tested to be 58 degrees, while the contact angle of the susceptor 30 made of J85 permalloy was tested to be about 65 degrees. The water droplets tend to be flat and spread on the surface, and cannot form a shape similar to the ellipsoid shape of the lotus effect.

S30: anti-adhesion test for tobacco slags: the result showed that after the fifth to sixth cigarettes were smoked, agglomeration (the area thereof is greater than 4 mm²) of tobacco slags and condensate oil remarkably visible to the naked eyes appeared on the surface of the susceptors 30 made of SS430 stainless iron and J85 permalloy, and the agglomeration cannot be removed by mouth blowing and shaking and needs to be wiped with alcohol cotton ball.

### Second Comparative Example

In the second comparative example, the commonly used permalloy susceptor 30 with a high-gloss ceramic glaze layer was subjected to the following three comparative tests:

S10: 48H salt spray test: 5% saline water was formulated and placed in a salt spray machine, then the temperature in the salt spray machine is set to be 35° C. to start spraying for 48 hours; the result is that the susceptor 30 can pass the 48H salt spray test.

S20: the contact angle of the surface thereof was measured by contact angle measuring instrument JC-2000C1 (produced by Shanghai Zhongchen Digital Technology Equipment Co., Ltd.), and the contact angle with water of the permalloy susceptor 30 with the high-gloss ceramic glaze layer was tested to be about 67 degrees, and the water droplets did not form a shape similar to the ellipsoid shape of the lotus effect on the surface.

S30: anti-adhesion test for tobacco slags: after the fifth to sixth cigarettes were smoked, agglomeration (the area thereof is greater than 4 mm²) of tobacco slags and condensate oil remarkably visible to the naked eyes appeared on the surface of the ceramic glaze layer, and the agglomeration cannot be removed by mouth blowing and shaking and needs to be wiped with alcohol cotton ball.

S40: impact resistance test: cracks occurred on the glaze layer after being tested for three times by a falling ball tester (setting machine parameters W=49N, h=30 cm).

As can be seen from the above description, the susceptor 30 of the present application, which is made of the composite material of nano-ceramic and organic polymer and has the micro-nano structure on the surface, has a better effect in preventing the adhesion of tobacco slags, condensate oil or the like of cigarettes that is heated without burning. Furthermore, the susceptor 30 has no brittleness defect of ordinary inorganic ceramic or high-gloss ceramic glaze coating in performance, and is more excellent in service life and stability.

It shall be noted that the preferred embodiments of the present application are given in the specification and attached drawings of the present application, but the present application are not limited to the embodiments described in this specification. Furthermore, those of ordinary skill in the art can make improvements or changes according to the above description, and all these improvements and changes shall fall within the scope claimed in the appended claims of the present application.

What is claimed is:

1. A susceptor for an aerosol generating device, comprising:
a metal body, being penetrable by a changing magnetic field to generate heat;
a protective layer provided on the metal body, wherein the protective layer has a surface micro-nano structure with a lotus effect so that the adhesion or deposition of organic substances from a smokable material on the surface of the susceptor is reduced.

2. The susceptor for an aerosol generating device according to claim 1, wherein the thickness of the protective layer ranges from 5 μm to 35 μm.

3. The susceptor for an aerosol generating device according to claim 1, wherein the protective layer comprises a ceramic material and an organic polymer material.

4. The susceptor for an aerosol generating device according to claim 3, wherein the ceramic material comprises at least one of aluminium oxide and titanium dioxide.

5. The susceptor for an aerosol generating device according to claim 3, wherein the organic polymer material comprises polyorganosiloxane.

6. The susceptor for an aerosol generating device according to claim 5, wherein the weight percentage of the polyorganosiloxane in the protective layer is less than 5%.

7. The susceptor for an aerosol generating device according to claim 5, wherein the polyorganosiloxane comprises at least one of methyl silicone oil, dimethyl silicone oil or ethyl silicone oil.

8. The susceptor for an aerosol generating device according to claim 1, wherein the hot state pencil hardness of the protective layer is from 6H to 8H under GB/T6739-2006 standard.

9. The susceptor for an aerosol generating device according to claim 1, wherein a water contact angle of the surface of the protective layer is greater than 120 degrees.

10. The susceptor for an aerosol generating device according to claim 1, wherein the adhesion level between the protective layer and the metal body reaches Grade 1.

11. The susceptor for an aerosol generating device according to claim 1, wherein a thermal decomposition temperature of the protective layer is greater than 320° C.

12. An aerosol generating device for heating a smokable material to generate aerosol, comprising:
a cavity, being configured to receive at least a part of the smokable material;
a magnetic field generator, being configured to generate an alternating magnetic field;
an induction heater, being configured to be penetrated by the alternating magnetic field to heat the smokable material received in the cavity;
wherein the induction heater comprises a susceptor comprising:
a metal body, being penetrable by a changing magnetic field to generate heat;
a protective layer provided on the metal body, wherein the protective layer has a surface micro-nano structure with a lotus effect so that the adhesion or deposition of organic substances from a smokable material on the surface of the susceptor is reduced.

13. The aerosol generating device according to claim 12, wherein the thickness of the protective layer ranges from 5 μm to 35 μm.

14. The aerosol generating device according to claim 12, wherein the protective layer comprises a ceramic material and an organic polymer material.

15. The aerosol generating device according to claim 14, wherein the ceramic material comprises at least one of aluminium oxide and titanium dioxide.

16. The aerosol generating device according to claim 14, wherein the organic polymer material comprises polyorganosiloxane.

17. The aerosol generating device according to claim 16, wherein the weight percentage of the polyorganosiloxane in the protective layer is less than 5%.

18. The aerosol generating device according to claim 16, wherein the polyorganosiloxane comprises at least one of methyl silicone oil, dimethyl silicone oil or ethyl silicone oil.

19. The aerosol generating device according to claim 12, wherein the hot state pencil hardness of the protective layer is from 6H to 8H under GB/T6739-2006 standard.

20. The aerosol generating device according to claim 12, wherein a water contact angle of the surface of the protective layer is greater than 120 degrees.
